(19) United States
(12) Patent Application Publication
(10) Pub. No.: US 2015/0254721 A1
(43) Pub. Date: Sep. 10, 2015

(54) PROVIDING AN ADVERTISEMENT IN ASSOCIATION WITH AVAILABLE PARKING

(71) Applicant: Ali Ajdari RAD, Adliswil (CH)

(72) Inventor: Ali Ajdari RAD, Adliswil (CH)

(73) Assignee: GOOGLE INC., Mountain View, CA (US)

(21) Appl. No.: 13/539,170

(22) Filed: Jun. 29, 2012

(51) Int. Cl. G06Q 30/02; G08G 1/14

(52) U.S. Cl. CPC G06Q 30/0266; G06Q 30/0267

(57) ABSTRACT

A system and method for providing an advertisement. A request for available parking for a user associated with a mobile device is received from a mobile device. A location of the user is determined, and a location of available parking is determined based on the determined location of the user. The location of available parking is provided to the mobile device, and an indication that the user has occupied the available parking is received. An advertisement associated with the occupied location of the available parking is determined and the display of the advertisement on the mobile device is provided after receiving the indication that the user has occupied the available parking.

### BACKGROUND

1. Field

The present disclosure generally relates to the display of advertisements, and more particularly to providing for display of advertisements specific to locations associated with available parking through a parking application on a user's electronic device.

2. Description of the Related Art

Applications for electronic devices can allow users to search for available parking based on the user's location, the user's destination, or other criteria. Advertisements may be shown to the user without regard to the information being sought by the user accessing the application.

### SUMMARY

The disclosed subject technology relates to providing an advertisement. The method includes receiving a request from a mobile device, wherein the request is for available parking for a user associated with the mobile device. The method may also include determining a location of the user and determining a location of available parking based on the determined location of the user. The method additionally includes providing the location of available parking to the mobile device, receiving an indication that the user has occupied the available parking, determining an advertisement associated with the occupied location of the available parking, and providing for display of the advertisement on the mobile device after receiving the indication that the user has occupied the available parking.

The disclosed subject technology further relates to a system for providing an advertisement. The system includes one or more processor(s) and a memory containing processor-executable instructions. When executed by the processor(s), the system receives a request from a mobile device, wherein the request is for available parking of a user associated with the mobile device, determines a location of the user, and determines a location of available parking based on the determined location of the user. The system also determines a first advertisement associated with the location of the available parking, provides for display of the location of available parking and for display of the first advertisement on the mobile device, and receives an indication that the user has occupied the available parking. The system further determines a second advertisement associated with the occupied available parking and provides for display of the second advertisement on the mobile device.

The disclosed subject technology also relates to a machine-executable storage medium comprising machine-readable instructions for providing an advertisement. The method includes receiving a request from a mobile device, wherein the request is for available parking for a user associated with the mobile device, determining a location of the user, and determining a location of available parking based on the determined location of the user. The method further includes determining a first advertisement associated with the location of the available parking, providing for display of the location of available parking and for display of the first advertisement on the mobile device, and receiving an indication that the user has occupied the available parking. The method further includes determining a second advertisement associated with the occupied available parking, providing for display of the second advertisement on the mobile device, receiving an indication that the user has vacated the available parking, and providing for display of a third advertisement on the mobile device upon receipt of the indication that the user has vacated the available parking.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example system for providing an advertisement.

FIG. 2 is a block diagram illustrating an example client and server from the system of FIG. 1.

FIG. 3 illustrates an example process for providing an advertisement.

FIG. 4 illustrates the flow of an example process for providing advertisements.

FIG. 5 is a block diagram illustrating an electronic system with which some implementations of the subject technology are implemented.

### DETAILED DESCRIPTION

In the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

The disclosed subject technology describes systems and techniques for providing an advertisement. Parking applications available on mobile phones or other devices assist drivers with locating available parking. Available parking may be requested near a user entered destination. Locations of available parking may be determined by the application based on the location of street signs indicating parking on a street, user entered information designating available parking, satellite imagery, or street level imagery. Available parking may include parking along a street, parking spaces, parking lots or any other type of parking for any type of vehicle. A street sign indicating available parking may have a location that is associated with one or more available parking spaces. Users of the parking application may enter a destination in the parking application and be provided with available parking near the destination. Indication of the user occupying one of the available parking spaces may be provided by a user entered acknowledgment of parking in the space such as a “check-in,” geolocation information of the user from the user's mobile device indicating that the user has stopped moving near the location of the parking space, or the geolocation of the user from the user's mobile device near the location of the parking space.

It may be beneficial to provide location specific advertisements to the user through such an application. Such applications may allow advertisers to choose location specific advertising based on the knowledge that the user is at a specific parking space near a destination location.

The disclosed method of providing a user with an advertisement may include receiving a request for available parking and determining a location associated with the available parking. The user request for parking and the available parking that is provided to the user may be associated with a destination location entered by the user. An advertisement associated with the location of available parking may be shown to the user via the parking application upon acknowledgment that the user has entered the parking space. One or more advertisements may be shown to the user through the parking application at one or more points of: the user requesting parking, the user receiving available parking information, receipt of an indication that the user has occupied one of the parking spaces, or receipt of an indication of the user's departure from the parking space.

The method may similarly be applied to other mobile device applications that indicate a user's destination such as public transit applications, applications that provide directions, and applications that track user movement.

Examples provided herein describe a user's information (e.g., the user's current location) that may be associated with a user account. However, in some example aspects, the user can, at any time, adjust privacy settings to selectively limit the types of user information that is accessed by the subject technology and/or shared with other users.

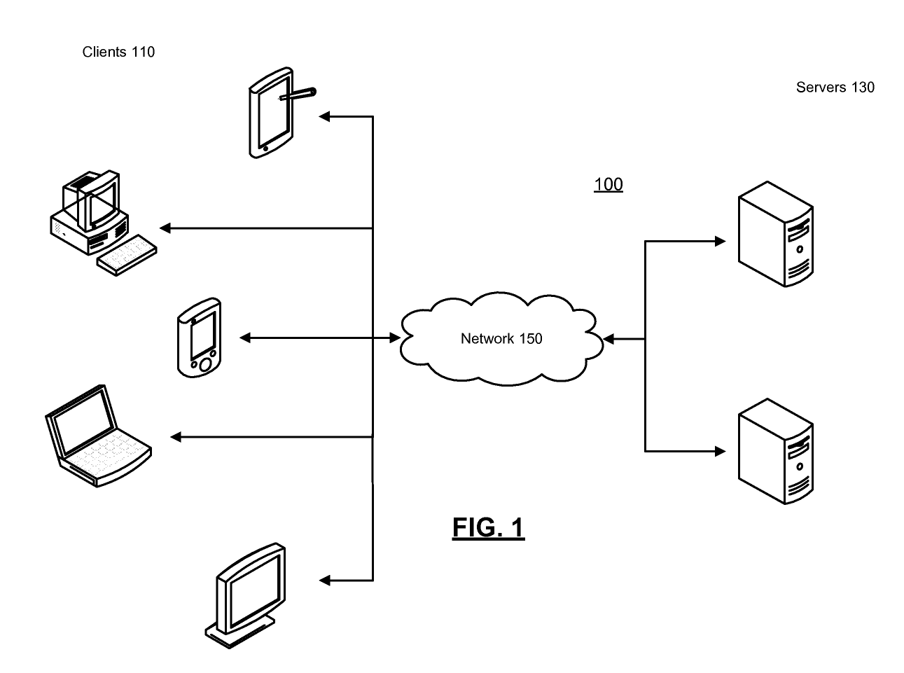

Turning to the drawings, FIG. 1 illustrates an example system 100 for providing an advertisement. The system 100 includes clients 110 and servers 130 connected over a network 150. Client 110 may request available parking information to server 130 over network 150. The client 110 may send information related to a location of a user to server 130 over network 150. Server 130 may determine a location of available parking for the location of the user and provide the location of available parking and an advertisement associated with the location of the available parking to client 110 over network 150. Client 110 may display the received available parking information and the advertisement.

The system 100 is comprised of client(s) 110, server(s) 130 and the network 150 in any combination or configuration that allows for providing an advertisement, including implementations with multiple servers 130. Each of the clients 110 can be, for example, a desktop computer, a laptop computer, a mobile device (e.g., a smartphone, tablet computer, or PDA), a set top box (e.g., for a television), a television with one or more processors embedded therein or coupled thereto, a video game console, or any other device having a processor, memory, and communications capabilities. In certain instances, different versions and/or configurations of the system that include subject technology as disclosed herein are available for download from a server 130 and subsequent installation on client 110. The servers 130 can be any device having a processor, memory, and communications capability for hosting the data for installing and hosting the system. In some example aspects, server(s) 130 can be a single computing device such as a computer server. In other embodiments, server(s) 130 can represent more than one computing device working together to perform the actions of a server computer (e.g., cloud computing).

The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a ring network, a mesh network, a star-bus network, tree or hierarchical network, and the like.

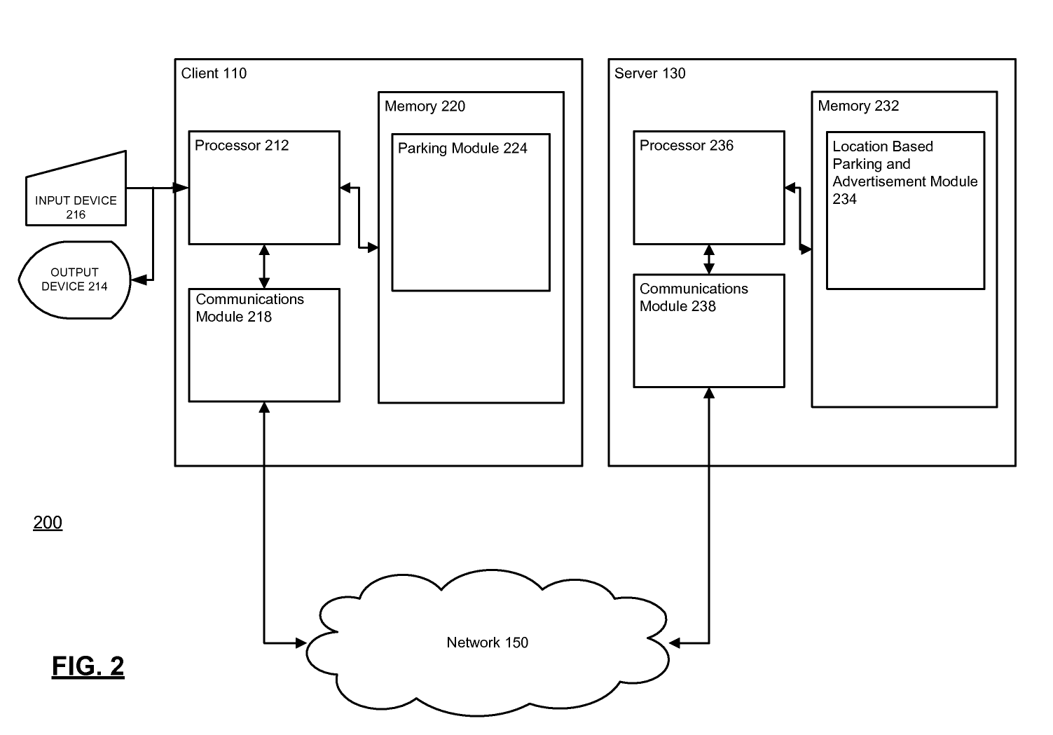

FIG. 2 is a block diagram illustrating an example client and server from the system 100 of FIG. 1 according to certain aspects of the subject technology. The client 110 and the server 130 are connected over the network 150 via respective communications modules 218 and 238 and are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220 that may include a parking module 224. Memory 220 may additionally include a database storing parking information of the user including previous locations of the user. The processor 212 of the client 110 is configured to execute instructions, such as instructions physically coded into the processor 212, instructions stored in memory 220, or a combination of both. The input device 216 may provide input to processor 212 which is processed by the parking module 224 stored in memory 220. The input may then be sent through network 150 via communications module 218 to server 130, which receives the information through communications module 238. Parking module 224 may provide a user interface in which the user may enter a location, may store locations of the user, and may receive information regarding the user's current geolocation from other portions of client 110.

Server 130 includes a processor 236, the communications module 238, and a memory 232 that may include a location based parking and advertisement module 234. Memory 232 may additionally include a database storing available parking information and advertisements that may be associated with the available parking information. Processor 236 is configured to execute instructions, such as instructions physically coded into the processor 236, instructions stored in memory 232, or a combination of both.

Processor 236 processes information from a location based parking and advertisement module 234 and sends information through communications module 238, through network 150, to client 110 to be displayed on output device 214. Location based parking and advertisement module 234 determines the location of available parking based on the location of the user and determines advertisements associated with the available parking and provides the location of available parking and associated advertisements for display to the user.

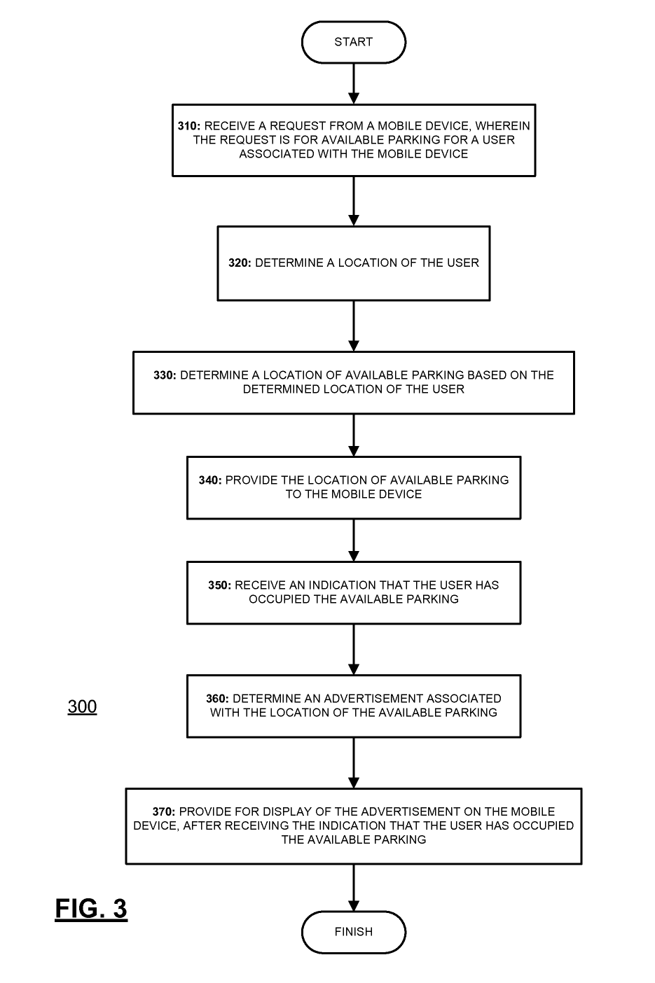

FIG. 3 illustrates an example process 300 for providing an advertisement as shown by the example client 110 and server 130 of FIG. 2. Although process 300 of FIG. 3 is described with reference to FIG. 2, the process 300 is not limited to such a configuration and can be applied to other systems and configurations.

The process begins with step 310, in which a request for available parking is received. The user may initiate the request for available parking through a graphical interface of a parking application on a client 110, such as a mobile device or a navigation device. The user may enter the request for parking in conjunction with a request for directions to a destination location.

An initial advertisement may be provided for display through the graphical interface of the parking application on client 110 upon receipt of the request for available parking. The initial advertisement may be associated with the current location of the user, information included in the request for available parking, or may be entirely unassociated with the request.

The term “available parking” as used herein encompasses its plain and ordinary meaning, including, but not limited to, one or more physical spaces in which a vehicle of any sort may be left unattended for a length of time. Available parking may include street side parking that is unmarked, marked with one or more signs, and may include one or more painted lines indicating spaces for individual vehicles. Available parking may also include parking spaces that are pay parking spaces, parking spaces that are free of charge, and spaces that are free at certain times and pay at other times. Available parking also includes parking areas that are restricted parking areas or restricted parking areas at specific times.

The term “vehicle” as used herein encompasses its plain and ordinary meaning, including, but not limited to automobiles, trucks, vans, campers, boats, mobile homes, motorcycles, scooters, motor driven bicycles, manually powered bicycles, skateboards, strollers, or any other device that may assist a person with travelling from one destination to another.

In step 320, a location of the user is determined. The location of the user may be the location of the user as entered by the user through client 110 or may be determined by the client 110 itself through a Global Positioning System (GPS), multilateration, or the like. The location of the user may be the current location of the user, a destination of the user that has been entered into a navigational system, any location entered by the user, or the like.

The location of the user may be determined at the point in which the user opens a parking application on client 110. Location information may be entered by the user via a graphical interface provided by parking module 224. The parking application may also include navigational services.

In step 330, a location of available parking based on the determined location of the user is determined by location based parking and advertisement module 234. Locations of available parking may be determined based on a location of a street sign designating the available parking. That is, a photograph of a street sign that is physically located near available parking may be analyzed to determine the times during which a street is available as street parking. Other users may indicate a location of available parking through a parking or a map application via a graphical interface. Locations of available parking may be determined based on satellite imagery (e.g., photographs or video depicting available parking spots), or a location of available parking may be determined based on street level imagery (e.g., photographs or video depicting available parking spots). Available parking information may be stored in a database of available parking in memory 232 of one or more servers 130.

The location of available parking may be based on the determined location of the user. The location of available parking may be determined to be within a preset distance from a destination of the user that is the location of the user. The preset distance from the destination may be a distance that is related to the distance the user is willing to walk. The location of available parking may be the closest available parking to the destination, or a location of available parking that is located along a driving route of the user. The location or locations of available parking may be chosen based on further criteria, such as the direction of travel of the user, direction of travel along a street, level of traffic, number of individual parking spaces that are available in a single location, or the like. The location of available parking may be additionally determined based on available parking that is unoccupied by a vehicle at the time the request for available parking is received. The location of available parking may be a single available parking space or may indicate an area such as a street that is available for parking. One or more advertisements may be associated with each location of available parking.

In step 340, the location of available parking is provided to the mobile device. The location of available parking may be displayed to the user in a map display of a graphical interface of the parking application on the client 110. The one or more advertisements may be displayed to the user along with the location of available parking via the graphical interface of the parking application.

Multiple locations of available parking may be provided to the client 110. Advertisements that are displayed along with the location of available parking may be associated with one or more of the locations of available parking. Advertisements may be displayed in a rotating fashion, such that one advertisement is displayed for a short period of time and subsequently replaced by another advertisement associated with one of the locations of available parking. The length of time during which the advertisement is displayed may be associated with a cost per unit of time that is chosen by the advertiser. The frequency with which an advertisement is displayed may also be determined based on a price associated with frequency that is chosen by the advertiser.

In step 350, an indication that the user has occupied the available parking is received. The indication that the user has occupied the available parking may be determined based on the geolocation of the user as determined by the client 110 or may be entered by the user into a user interface of the client 110 indicating that the user has occupied the available parking.

In step 360, an advertisement associated with the occupied location of the available parking is determined.

Advertisements may be associated with one or more locations of available parking based on parameters specified by the advertiser. An advertiser may specify which locations of available parking she would like to associate each advertisement with.

For instance, an advertiser may indicate that his advertisements are to be associated with available parking that is located within a one mile radius of a store that is the subject of the advertisement. In this vein, the advertiser may then ensure that his advertisement is shown only to users who are already in the vicinity of the store with a high likelihood that the user will be in the area for a period of time. Similarly, an advertiser may target her audience by associating her advertisements with locations of available parking near other businesses that offer similar services. For instance, a freelance translator may wish to have her advertisements associated with locations of available parking near a business that offers foreign language classes.

An advertisement may be associated with a single location of available parking or may be associated with a variety of locations. The location associated with the advertisement may be time specific. For instance, an advertisement may be associated with a larger number of locations of available parking on Mondays through Fridays during regular business hours, and the advertisement may be associated with a smaller number of locations of available parking on weekends and evenings. The advertisement may be associated with a location during specific days of the week, or hours in the day, and is not associated with the location of available parking at times that are not explicitly specified. Location specific advertisements may be displayed in rotation with advertisements that do not have locations specified.

The process ends in step 370, where the advertisement is provided to the mobile device for display after receiving the indication that the user has occupied the available parking

An indication that the user has vacated the available parking may be provided. The indication that the user has vacated the available parking may be determined based on the geolocation of the user as determined by the client 110 or may be entered by the user into a user interface of the client 110 indicating that the user has vacated or is about to vacate the available parking

A final advertisement may be determined that is associated with the location of vacated available parking, the direction of travel as the user moves away from the vacated available parking, a new destination location of the user, or may be entirely unassociated with the location of the user. The final advertisement may be provided upon receipt of the indication that the user has vacated the available parking. The final advertisement may take the place of other advertisements that have been provided for display, or the final advertisement may be displayed in addition to other advertisements that have been provided for display. The final advertisement may include multiple advertisements or may be provided for display in a time-based rotating fashion with previously displayed advertisements.

The process above may be adapted to provide one or more advertisements to users requesting public transit information instead of parking information. The process may be augmented to show advertisements when a user requests transit stations near a user's current location or transit stations near a destination location. A user may be shown an advertisement based on an indication that the user has boarded public transit at a specific stop, or an indication that the user has de-boarded public transit at a specific stop. The process above may be adapted for specific clients 110 such as mobile devices, navigation systems, or any other portable computing device.

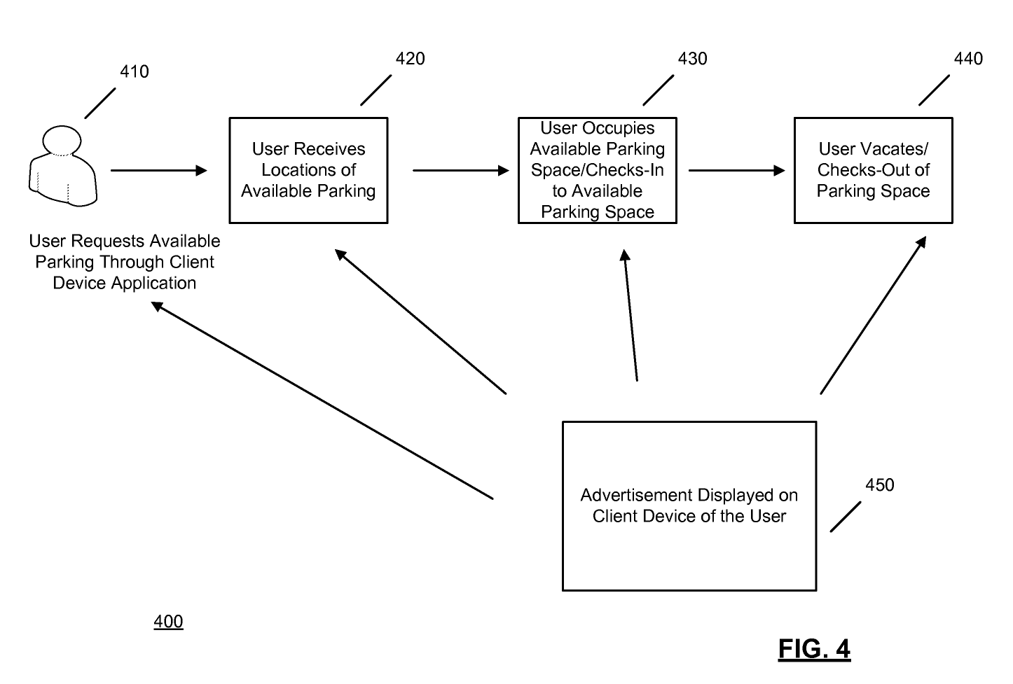

FIG. 4 illustrates the flow of an example process for providing advertisements. In FIG. 4, advertisements may be displayed 450 at one or more times during the process of the user requesting, receiving, occupying, and vacating available parking. Advertisements for display may occur at any one or more points of the flow diagram. A different advertisement may be displayed at different points 410, 420, 430, and 440 of the flow. Advertisements may be associated with different locations at different points of the flow 410-440.

The user makes a request 410 for available parking through a client device application. At this time, an advertisement that is displayed on the client device of the user 450 may be associated with a current location of the user, location information entered in the request, or the like. At 420, when the user receives locations of available parking, an advertisement displayed on the client device of the user 450 may be associated with the received locations of available parking. A single advertisement may be shown at this point in the flow and chosen amongst all advertisements that are associated with the locations of available parking. An advertisement may be displayed on the client device of the user 450 at point 430, the point when the user occupies available parking or provides a check or indicator that the available parking space has been occupied. An advertisement at this point in the flow may be associated with the specific location of the available parking that is occupied by the user. An advertisement may be displayed on the client device of the user 450 at point 440 when the user vacates the available parking, provides an indication that the user has vacated the parking space, or checks out of the parking space. An advertisement shown at this point in the flow may be associated with the location of the vacated parking space, the new direction of travel of the user, or a new destination location that has been entered into the client device by the user.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject technology can be implemented as sub-parts of a larger program while remaining distinct software aspects of the subject technology. In some implementations, multiple software aspects can also be implemented as separate programs. Finally, any combination of separate programs that together implement a software aspect described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

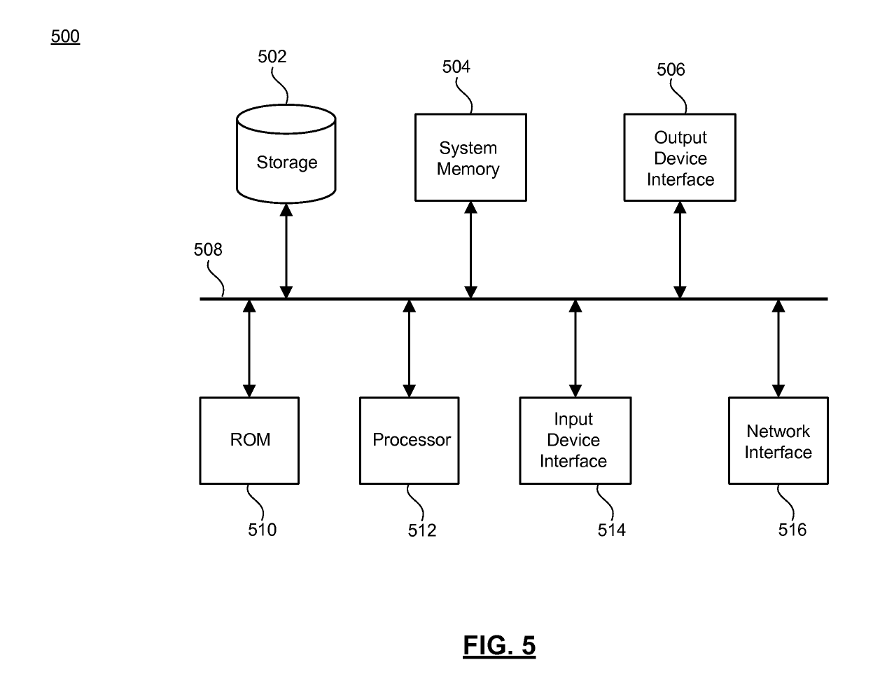

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject technology. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject technology use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as a random access memory. System memory 504 stores some of the instructions and data that the processor needs at runtime. In some implementations, the processes of the subject technology are stored in system memory 504, permanent storage device 502, and/or ROM 510. For example, the various memory units include instructions for providing an advertisement in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers such as a local area network (“LAN”), a wide area network (“WAN”), or an Intranet, or a network of networks, such as the Internet. Any or all components of electronic system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject technology described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject technology described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology. Features described under one heading or one subheading of the subject disclosure may be combined, in various aspects, with features described under other headings or subheadings. Further it is not necessarily the case that all features under a single heading or a single subheading are used together in aspects.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for providing an advertisement, the method comprising:
receiving, by one or more computing devices, a request from a mobile device, wherein the request is for available parking for a user associated with the mobile device;
providing to the user, by the one or more computing devices, an initial advertisement upon receipt of the request for available parking;
determining, by the one or more computing devices, a location of the user at least in part by a geolocation system associated with the mobile device;
determining, by the one or more computing devices, a location of available parking based on the determined location of the user, the available parking comprising one or more parking spots, each having one or more predetermined associated advertisements;
providing to the user, by the one or more computing devices, the location of available parking to the mobile device;
receiving, by the one or more computing devices, an indication that the user has occupied the available parking, based at least in part on the geolocation system;
determining, by the one or more computing devices, an additional advertisement associated with the occupied location of the available parking from the one or more associated advertisements; and
providing to the user, by the one or more computing devices, the additional advertisement after receiving the indication that the user has occupied the available parking.

2. The method of claim 1, wherein the location of available parking is based on at least one of a location of a street sign designating the available parking, a location that has been indicated by others as available parking, a location of available parking based on satellite imaging, or a location of available parking based on street level imagery.

3. The method of claim 1, wherein the location of available parking corresponds to unoccupied available parking at the time the request for available parking is received.

4. The method of claim 1, wherein the indication that the user has occupied the available parking is based at least on a user entered acknowledgement, received from the mobile device, of occupying the available parking.

5. The method of claim 1, wherein the available parking corresponds to at least one available parking space associated with a destination of the user.

6. (canceled)

7. The method of claim 1, wherein the request is received from a parking application on the mobile device, and wherein at least one of the initial advertisement and the additional advertisement is displayed through a graphical interface of the parking application on the mobile device.

8. The method of claim 1, wherein the initial advertisement is configured to be displayed through a graphical interface of a parking application on the mobile device.

9. The method of claim 1, wherein the additional advertisement and the location of available parking are configured to be displayed through the graphical interface of the parking application on the mobile device.

10. The method of claim 1, further comprising:
receiving an indication that the user has vacated the available parking; and
providing a final advertisement upon receipt of the indication that the user has vacated the available parking.

11. A system for providing an advertisement, the system comprising:
one or more processors; and
a memory containing processor-executable instructions that, when executed by the one or more processors, cause the system to:
receive a request from a mobile device, wherein the request is for available parking for a user associated with the mobile device;
determine a location of the user based at least in part on a geolocation, system associated with the mobile device;
determine a location of available parking based on the determined location of the user, the available parking comprising one or more parking spots, each having one or more predetermined associated advertisements;
determine a first advertisement associated with the location of the available parking from the one or more advertisements;
provide the location of available parking and the first advertisement to the user, the location of available parking and the first advertisement configured to be displayed on the mobile device;
receive an indication that the user has occupied the available parking, based at least in part on the geolocation system;
determine a second advertisement associated with the occupied available parking; and
provide the second advertisement to the user after receiving the indication that the user has occupied the available parking, the second advertisement configured to be displayed on the mobile device.

12. The system of claim 11, wherein the location of available parking is based on at least one of a location of a street sign designating the available parking, a location that has been indicated by others as available parking, a location of available parking based on satellite imaging, or a location of available parking based on street level imagery.

13. The system of claim 11, wherein the location of available parking corresponds to unoccupied available parking at the time the request for available parking is received.

14. The system of claim 11, wherein the indication that the user has occupied the available parking is based at least in part on a user entered acknowledgement, received from the mobile device, of entering the available parking.

15. The system of claim 11, wherein the available parking corresponds to at least one available parking space associated with a destination of the user.

16. (canceled)

17. The system of claim 11, wherein the request is received from a parking application on the mobile device, and wherein the first advertisement and the second advertisement are displayed through a graphical interface of the parking application on the mobile device.

18. The system of claim 11, wherein the system is further caused to:
receive an indication that the user has vacated the available parking; and
provide a third advertisement upon receipt of the indication that the user has vacated the available parking, the third advertisement configured to be displayed on the mobile device.

19. A non-transitory machine-readable storage medium storing machine-executable instructions for causing a processor to perform a method for providing an advertisement, the method comprising:
receiving a request from a mobile device, wherein the request is for available parking for a user associated with the mobile device;
determining a location of the user based at least in part on a geolocation system associated with the mobile device;
determining a location of available parking based on the determined location of the user, the available parking comprising one or more parking spots, each having one or more predetermined associated advertisements;
determining a first advertisement associated with the location of the available parking from the one or more associated advertisements;
providing the location of available parking and the first advertisement to the user, the location of available parking and the first advertisement configured to be displayed on the mobile device;
receiving an indication that the user has occupied the available parking based at least in part on the geolocation system;
determining a second advertisement associated with the occupied available parking;
providing the second advertisement to the user after receiving the indication that the user has occupied the available parking, the second advertisement configured to be displayed on the mobile device;
receiving an indication that the user has vacated the available parking; and
providing a third advertisement to the user upon receipt of the indication that the user has vacated the available parking, the third advertisement configured to be displayed on the mobile device.

20. The non-transitory machine-readable storage medium of claim 19, wherein the location of available parking is based on at least one of a location of a street sign designating the available parking, a location that has been indicated by others as available parking, a location of available parking based on satellite imaging, or a location of available parking based on street level imagery.

21. The non-transitory machine-readable storage medium of claim 19, wherein the location of available parking corresponds to unoccupied available parking at the time the request for available parking is received.

22. The non-transitory machine-readable storage medium of claim 19, wherein the indication that the user has occupied the available parking is based at least in part on a user entered acknowledgement, received from the mobile device, of entering the available parking.

23. The non-transitory machine-readable storage medium of claim 19, wherein the request is received from a parking application on the mobile device, and wherein the first advertisement, the second advertisement and the third advertisement are displayed through a graphical interface of the parking application on the mobile device.
